(19) United States
(12) Patent Application Publication
(10) Pub. No.: US 2005/0018928 A1
(43) Pub. Date: Jan. 27, 2005

(54) Method for dynamically editing and enhancing image-processing chains in medical imaging equipment

(76) Inventors: Base V. Paul, Cochin (IN); Dalesh S. Dharamshi, Bangalore (IN); Srikanth Jayaram, Bangalore (IN); Vinay Parthan, Bangalore (IN); Lakshmi N. Gudapakkam, Algonquin, IL (US)

Correspondence Address: QUARLES & BRADY LLP, 411 E. WISCONSIN AVENUE, SUITE 2040, MILWAUKEE, WI, 53202-4497, US

(21) Appl. No.: 10/611,726

(22) Filed: Jul. 1, 2003

(51) Int. Cl. G06K 9/54

(52) U.S. Cl. 382/303

(57) ABSTRACT

A method for adding an image processing algorithm (18a) for execution by a compiled image processing computer program (41), without recompiling the image processing computer program, includes specifying image processing elements (13-17, 13a-17a) in an image processing chain (10, 10a), applying the image processing elements in a sequence or in parallel to one or more resulting images to be displayed, generating an image processing chain as a script capable of execution by a script interpreter (46) in the computer (36) which is arranged to receive raw image data (11, 11a), and relating the image processing chain (10a) to a clinical protocol (55), which is subsequently executed by the computer while running the compiled image processing computer program to process image data.

### CROSS REFERENCE TO RELATED APPLICATIONS

Not applicable.

### STATEMENT REGARDING FEDERALLY SPONSORED RESEARCH

Not applicable.

### TECHNICAL FIELD

The field of the invention is methods for operating digital medical imaging equipment, including x-ray machines, ultrasound imaging machines, CT scanners, magnetic resonance (MR) scanners, nuclear MR or PET scanners.

### BACKGROUND ART

Medical imaging equipment, such as an x-ray device, or a CT scanner or an ultrasound scanner, is typically connected to a computer or workstation, which is used to obtain, process and store image data which can be processed and displayed as images. The image data is captured as raw data that contains artifacts inherent in the different imaging technologies being used.

During image acquisition (when the patient is within the scan room), the image data undergoes a set of transformations before the image is displayed on a monitor. In some cases, these transformations are performed by hardware and in other cases they are performed by software. The medical professional then reviews the images for a patient or saves the images and recalls them later for more diagnostics. During this time, the reviewer typically applies other sets of processing on those images.

Image processing algorithms are applied to the raw image data, so that the image can be better viewed and analyzed by the medical professional. There are many image processing algorithms that add diagnostic value to these images. Image processing is a research field in itself, with many algorithms of high diagnostic value being continually developed. New image processing algorithms are often developed and integrated into the imaging system.

Currently, image processing application software is developed as a package in a programming language such as C++ and is then compiled for distribution to customers who purchase, lease or own the scanning equipment. Integration of new algorithms requires recompiling the application software.

A major drawback of this approach is the need to update and reinstall the imaging application software to add even a single new imaging processing algorithm. Another technical problem arises in integrating new image data processing algorithms, because these are often developed by third parties. The above-described system is also a custom software approach which is not interfaced with many commercially available development tools for developing image data processing algorithms.

### SUMMARY OF THE INVENTION

The invention provides a method for dynamically linking image processing algorithms in an image processing chain at the time of executing an image processing application. The invention also provides a method for adding new algorithms to existing image processing chains without the need for recompiling the application software.

This invention allows the medical professional, such as a radiologist, to customize the image processing used in a scanner without requiring a software update or reinstallation and without calling a service engineer.

The invention uses an interpreted language for linking and sequencing the image processing elements within image-processing chains, so that the chain can be changed dynamically. This interpreted language can be a fine-tuned version of a scripted (interpreted) language such as TCL (Tool Command Language), Perl, Python, or others known in the art.

The invention allows for any combination of the processing elements, in sequence or parallel, to create image-processing chains. The image-processing chains can be saved independently of the primary image processing software. These processing files can be easily edited, even with a normal text editor. It is also possible to provide a graphical user interface (GUI) tool to edit the image processing chains.

These and other objects and advantages of the invention will be apparent from the description that follows and from the drawings which illustrate a preferred embodiment of the invention, and which are incorporated herein by reference. Such embodiment does not necessarily represent the full scope of the invention, however, as this is reserved for the claims which follow the description.

### BRIEF DESCRIPTION OF THE DRAWINGS

FIG. 1 is a block diagram of a first image processing chain to be represented in the method of the present invention;

FIG. 2 is a block diagram of a second image processing chain which can represented in the method of the present invention;

FIG. 3 is a block diagram of a modification of the first image processing chain of FIG. 1 according to the present invention;

FIG. 4 is a system block diagram showing a system for executing the new image processing chains and algorithms developed with the present invention;

FIG. 5 is a time line chart showing a sequence for relating an image processing chain to a clinical protocol executed by a main image processing application; and

FIG. 6 is a time line chart showing a sequence of modifying an image processing chain and relating the image processing chain to a clinical protocol executed by the main image processing application.

### DETAILED DESCRIPTION

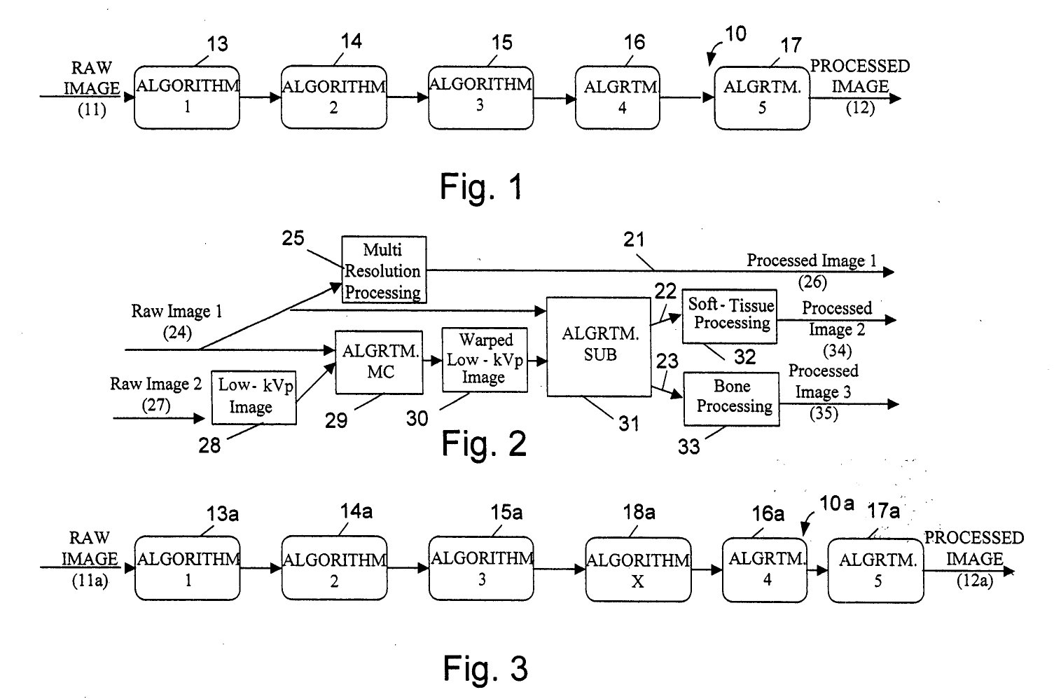

FIGS. 1 illustrates a simple image-processing chain (IP Chain) 10 for a digital RAD-type scanner as viewed according to the method of the current invention. This is used in single shot exposure where a single image is acquired.

The blocks in the imaging-processing chain 10 are applied to the raw imaging data 11 to produce a processed image 12. These process blocks 13-17 each include a respective algorithm which is executed when this block of the computer program is executed, and thus the blocks are labeled ALGORITHM 1-ALGORITHM 5, respectively.

Another more complex chain 20 with multiple branches is shown in FIG. 2. There are three image processing chains 21, 22, 23 (multi-resolution, soft-tissue and bone processing) that run in parallel. A first batch of raw image data 24 is processed by program instructions represented by a multi-resolution processing block 25 to produce a first processed image 26 in the first image processing chain 21.

A second batch of raw image data 27 is processed by program instructions in a low kVp image processing block 28. It is then processed with the first batch of raw image data 24 by a processing block of instructions 29 which includes an ALGORITHM MC. From there the two batches of data 24, 27 are processed by a warped low kVp image block of instructions 30 and an ALGORITHM SUB process block of instructions 31. The data can then be transmitted in parallel to a block of soft tissue image processing instructions 32 and to a block of bone image processing instructions 33. This produces two further processed images 34, 35.

As seen in the above diagrams, processed images (which have clinical value) are generated after applying a sequence of transformations or algorithms (represented as blocks) to the raw image data. These blocks (hereafter referred to as “processing elements” in this document) are often generic enough to be used with other processing elements.

Due to the complex relationships between different processing elements, these image processing chains have, until the present invention, been authored and compiled into the image processing application software. A predefined set of image processing chains have been distributed in the software. Various clinical protocols are hard-mapped within the software.

FIG. 3 illustrates an image processing chain 10a of the present invention. In this sequence of processing blocks, the blocks are authored in an interpreted, script-type language such as TCL (Tool Command Language). This interpreted language can be a fine-tuned version of scripted (interpreted) languages such as TCL, Perl, Python, or others known in the art. A script authored in one of these languages does not need recompiling for execution with the main image processing program.

The creation and modification of image processing chains using one of these languages involves the following activities:
1) specifying image processing elements in an image processing chain;
2) applying the image processing elements in a sequence or in parallel to one or more resulting images to be displayed;
3) constructing additional image processing chains from smaller image processing chains, with the smaller image processing chains being related in sequence or in parallel;
4) defining inputs for each image processing element;
5) defining outputs for each image processing element;
6) saving output images of different image processing chains; and
7) conditionally applying image processing chains.

These activities combined with the basics provided by these languages provide a powerful mechanism to create image-processing chains at runtime. It will allow any combination of the processing elements, in sequence or parallel, to create image-processing chains. These image-processing chains (represented as scripts) are then saved to script files. These script files can be easily edited, even with a normal text editor. It is also possible to provide GUI-based tool to edit the image processing chains.

In FIG. 3, blocks 13a-17a are blocks corresponding to blocks 13-17 in FIG. 1, except that blocks 13a-17a are authored as separate blocks in the program language of the main image processing application or in another suitable program language. In addition, a new block 18a is added to provide a new image processing algorithm, referred to as ALGORITHM X.

As an example of practicing the invention, consider the IP chain 10 for single shot mode shown in FIG. 1 above. That chain 10 can be represented in blocks using the newly proposed interpreted language as follows.
chainid=Sequential ALGORITHM 1, ALGORITHM 2, ALGORITHM 3, ALGORITHM 4 and ALGORITHM 5
SetInputImages $chainid IMGO (Defining the inputs)
ImgToSave=GetOutputImage $chainId 0
(Defining the outputs)

Now, if the processing chain is to be changed to that shown in FIG. 3, the changes will be the addition of the runtime editable representation file, ALGORITHM X and a modification of the image processing chain script to execute ALGORITHM X after ALGORITHM 3 and before ALGORITHM 4.

The new IP chain 10a can be represented as follows. There will be no change in the main image capture and processing application software.
chainId=Sequential ALGORITHM 1, ALGORITHM 2, ALGORITHM 3, ALGORITHM X, ALGORITHM 4 and ALGORITHM 5
SetInputImages $chainid IMGO (Defining the inputs)
ImgToSave=GetOutputImage $chainid 0
(Defining the outputs)

The image processing files, Sequential ALGORITHM 1, ALGORITHM 2, ALGORITHM 3, ALGORITHM X, ALGORITHM 4 and ALGORITHM 5, can then be read at runtime by the image-processing chain script.

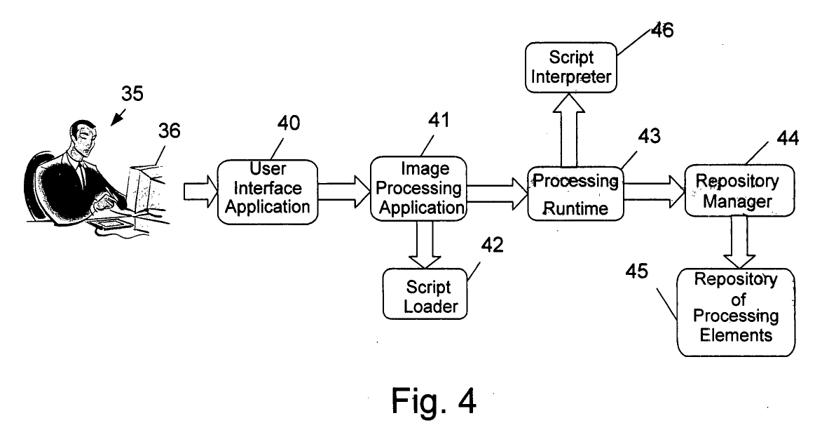

The high-level design for such a system to carry out the invention is shown in FIG. 4.

A user 35 enters or selects the processing to be applied from the user interface application 40 running on a computer 36 connected to an item of medical imaging equipment (not shown in FIG. 4). The computer can be a Pentium-based PC running a Windows operating system, or any other computer of similar or greater capabilities.

The user interface application 40 passes the scripted image processing chain module to the image processing application 41. The image processing application 41 loads the script modules for the selected image processing chains using a script loader 42. The image processing application 41 then passes the script modules to a runtime processing module 43. The runtime processing module 43 processes the script modules to configure them for execution during runtime of the main image processing application 41. The runtime processing module 43 uses a repository manager routine, represented by process block 44 to load common image processing elements from a stored library of image processing elements 45 called the repository of processing elements. An image “processing element” (PE) is a software entity that interfaces to a given image processing algorithm and interfaces it with the system. The other modules of the image processing chain are transparent to the new algorithm which is not concerned with the program environment, or where the processing element is arranged in the chain of processing elements. The script interpreter 46 will execute the image processing elements including the common processing elements and any custom algorithm elements entered or selected by the user.

The software on the user computer 36 for entering new processing elements (PE's) and configuring new image processing chains is referred to at the “IP administration tool.” Its main responsibility is to add or remove PE's into the computer 36 associated with the medical imaging scanner. Apart from this, IP administration tool defines policies to integrate new PE's. An example of such a policy is license agreements, which define how many processing elements can be added to the system, whether or not they can be added.

All the PE's are stored in the PE repository 45. This repository 45 is independent of the internal modules that use it. This ensures the least coupling with these modules that use PE's and helps easy integration of new PE's into the system. The IP administration tool interacts with this repository 45 to add new PE's into the system. The repository 45 includes a dedicated, nonvolatile storage device to store these processing elements, so that they will be permanently stored in the system, until they are removed using IP administration tool.

The invention provides a representation of an image processing chain such that it can be created or changed dynamically. This allows a radiologist or researcher to dynamically create, modify or delete an image processing chain (without requiring a source code change).

The invention also allows the dynamic mapping of a clinical protocol to an image processing chain. The invention allows the medical professional to customize the image processing used in their scanner without requiring a software update/reinstall or calling service engineer.

Information about this user-selected chain is stored in the clinical protocol database of the system when the protocol is saved. Later when the system is configured for that particular protocol, an image-processing chain (or script file) for that protocol from the database can be passed onto the image-processing module in the scanner. Thus the behavior of the image-processing module can be changed at runtime.

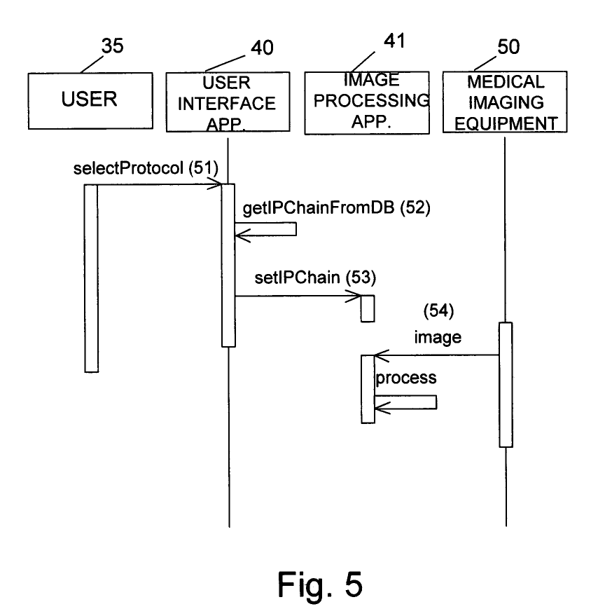

As shown in FIG. 5, the user 35 may select a clinical protocol from a stored database of such protocols, as represented by time line 51 using the IP administration tools in the user interface application 50. The user 35 may then retrieve an IP processing chain from the repository, as represented by time line 52, using the user interface application 40. The user 35 then relates the IP image processing chain to the clinical protocol 53 using the IP administration tools in the user interface application 40. Finally, as represented in FIG. 5, the image is acquired as raw data using the scanning equipment, as represented by time line 54, using the image processing application 41 and the medical imaging equipment 50.

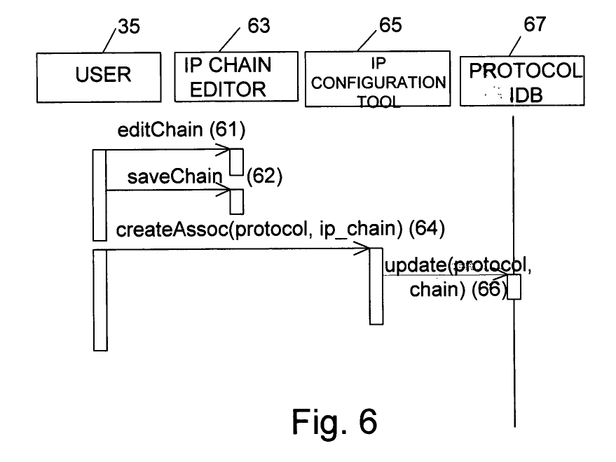

As shown in FIG. 6, a user 35 may modify an IP image processing chain represent by time lines 61, 62 using an IP chain editor 63 in the IP administration tools of the user interface application 40. The user may also associate the IP image processing chain with a clinical protocol as represented by time line 64. Next, the user uses an IP configuration tool 65 in the IP administration tools to update the IP image processing protocol 66 in a database 67 for execution during runtime.

With the invention, processing blocks of each image processing chain can be represented on the computer display associated with the medical imaging equipment 50 as human-readable strings. These processing elements are self-contained and independent of the element before or after it in the sequence of an image processing chain. This will also enable any processing element to be part of any image processing chain.

This has been a description of a preferred embodiment of the invention. It will be apparent that various modifications and details can be varied without departing from the scope and spirit of the invention, and these are intended to come within the scope of the following claims.

1. A method for dynamically controlling the sequence of execution of image processing algorithms, without recompiling an image processing computer program, the method comprising:
providing a plurality of image processing elements as self-contained modules which can be executed individually in a plurality of possible sequences;
providing an image processing chain in a script capable of execution by a script interpreter in a computer arranged to receive raw image data;
wherein the image processing chain determines a selected sequence of execution of the image processing elements; and
relating the image processing chain to a clinical protocol, which is subsequently executed by the computer while running a compiled image processing computer program to process image data.

2. The method of claim 1, wherein the plurality of processing elements in an image processing chain are stored in a repository of image processing elements for easy access during image processing chain editing operations.

3. The method of claim 2, wherein the repository of image processing elements is stored on a memory storage device dedicated to that function and accessible by the computer.

4. The method of claim 1, wherein the image processing chain be related to any one of a plurality of clinical protocols.

5. The method of claim 1, wherein the method is carried out by an administration tool comprising a plurality of image processing tools which can be installed on the computer associated with the item of medical imaging equipment and executing the image processing application to process the raw data into an image that can be displayed.

6. The method of claim 1, wherein the algorithm module is generated in a tool command language.

7. The method of claim 1, wherein the image processing chains are generated with a text editor.

8. The method of claim 1, wherein the raw image data is received from an item of medical imaging equipment.

9. The method of claim 8, wherein the medical imaging equipment is a CT scanner.

10. The method of claim 8, wherein the medical imaging equipment is an MR scanner.

11. The method of claim 8, wherein the medical imaging equipment is an ultrasound imaging machine.

12. The method of claim 8, wherein the medical imaging equipment is an x-ray RAD scanner.

13. A method for constructing image processing chains that can be easily edited for addition of new processing algorithms, the method comprising:
specifying image processing elements in an image processing chain;
applying the image processing elements in a sequence or in parallel to one or more resulting images to be displayed;
defining inputs for each image processing element;
defining outputs for each image processing element;
saving output images of different image processing chains.

14. The method of claim 13, further comprising:
constructing additional image processing chains from smaller image processing chains, said smaller image processing chains being related in sequence or in parallel.

15. The method of claim 15, further comprising conditionally applying image processing chains.

16. A method for adding an image processing algorithm to a compiled image processing computer program, without recompiling the image processing computer program, the method comprising:
providing a plurality of image processing elements as self-contained modules which can be executed individually in a plurality of possible sequences; and
providing an image processing chain in a script capable of execution by a script interpreter in a computer arranged to receive raw image data;
adding a new image processing element;
configuring the image processing chain to determine the sequence of execution of the image processing elements including the new image processing element; and
relating the image processing chain to a clinical protocol, which is subsequently executed by the computer while running the compiled image processing computer program to process image data.

17. The method of claim 16, further comprising:
modifying the image processing chain using a text editor; and
relating the modified image processing chain to a clinical protocol, which is subsequently executed by the computer while running the compiled image processing computer program to process image data

18. The method of claim 17, wherein the method is carried out by an administration tool comprising a plurality of image processing tools which can be installed on the computer associated with the item of medical imaging equipment and executing the image processing application to process the raw data into an image that can be displayed.

19. The method of claim 16, wherein the plurality of processing elements in an image processing chain are stored in a repository of image processing elements for easy access during image processing chain editing operations.

20. The method of claim 19, wherein the repository of image processing elements is stored on a memory storage device dedicated to that function and accessible by the computer.
